(19) United States
(12) Patent Application Publication
(10) Pub. No.: US 2011/0150328 A1
(43) Pub. Date: Jun. 23, 2011

(54) APPARATUS AND METHOD FOR BLOCKIING OBJECTIONABLE IMAGE ON BASIS OF MULTIMODAL AND MULTISCALE FEATURES

(75) Inventors: Seung Wan HAN, Gwangju (KR); Jae Deok Lim, Daejeon (KR); Byeong Cheol Choi, Daejeon (KR); Byung Ho Chung, Daejeon (KR)

(73) Assignee: Electronics and Telecommunications Research Institute, Daejeon (KR)

(21) Appl. No.: 12/966,230

(22) Filed: Dec. 13, 2010

(30) Foreign Application Priority Data
Dec. 21, 2009 (KR) 10-2009-0127868
Nov. 1, 2010 (KR) 10-2010-0107618

(51) Int. Cl. G06K 9/46

(52) U.S. Cl. 382/165; 382/190

(57) ABSTRACT

Provided are an apparatus and method for blocking an objectionable image on the basis of multimodal and multiscale features. The apparatus includes a multiscale feature analyzer for analyzing multimodal information extracted from image training data to generate multiscale objectionable and non-objectionable features, an objectionability classification model generator for compiling statistics on the generated objectionable and non-objectionable features and performing machine learning to generate multi-level objectionability classification models, an objectionability determiner for analyzing multimodal information extracted from image data input for objectionability determination to extract at least one of multiscale features of the input image, and comparing the extracted feature with at least one of the multi-level objectionability classification models to determine objectionability of the image, and an objectionable image blocker for blocking the input image when it is determined that the image is objectionable.

### CROSS-REFERENCE TO RELATED APPLICATION

This application claims priority to and the benefit of Korean Patent Application No. 10-2009-0127868, filed Dec. 21, 2009 and Korean Patent Application No. 10-2010-0107618, filed Nov. 1, 2010, the disclosure of which is incorporated herein by reference in its entirety.

### BACKGROUND

1. Field of the Invention

The present invention relates to an apparatus and method for blocking an objectionable image on the basis of multimodal and multiscale features, and more particularly to an apparatus and method analyzing and characterizing multimodal information, such as a color, texture, shape, skin color, face, edge, Motion Picture Experts Group (MPEG)-7 descriptor, object, object meaning, and object relationship, in multiple scales from already-known objectionable and non-objectionable image training data, generating a multi-stage objectionability classification model having multi-level complexities for objectionability classification using the analysis result, and determining objectionability of a newly input image using the objectionability classification model to block an objectionable image.

2. Discussion of Related Art

The Internet has a wide enough array of information to be called a “sea of information” and is convenient to use. For this reason, the Internet has become a part of many modern people's daily life and has a positive influence in social, economic, and academic aspects. However, in contrast to such a positive influence, indiscriminate circulation of objectionable information using the openness, mutual connectivity, and anonymity of the Internet is rising as a serious social problem. In particular, juveniles who can access the Internet anytime are exposed to objectionable information much more often than before. Such an environment may tempt and emotionally and mentally harm juveniles who have poor value judgment and poor self-control. Thus, a method of blocking objectionable information is required to prevent juveniles who are socially weak persons or persons who do not want objectionable information from being exposed to objectionable information.

Conventional methods of blocking an objectionable image include a metadata and text information-based blocking scheme, a hash and database (DB)-based blocking scheme, a content-based blocking scheme, and so on. In the metadata and text information-based blocking scheme, objectionability of the title of an image, a file name, and text included in a description is analyzed to determine objectionability of the image. The metadata and text information-based blocking scheme shows a high excessive-blocking rate and mis-blocking rate. In the hash and DB-based blocking scheme, hash values of already-known objectionable images are calculated and stored in a DB. After this, the hash value of a newly input image is calculated and compared with the values stored in the previously built DB to determine objectionability of the image. In the hash and DB-based blocking scheme, the greater the number of objectionable images, the greater the amount of computation for determining objectionability of an image as well as the size of the hash value DB. Also, when the hash value of an already-known objectionable image is changed by a small modification, the image cannot be blocked.

In the recently disclosed content-based blocking scheme, the content of an objectionable image is analyzed to extract a feature, an objectionability classification model is generated from the feature, and then objectionability of an input image is determined on the basis of the generated objectionability classification model. This scheme solves the problem of the high excessive-blocking rate and mis-blocking rate of the metadata and text information-based blocking scheme and the problem of the DB size and the amount of computation of the hash and DB-based blocking scheme.

However, most content-based blocking schemes use low-level features, such as a color, texture, and shape, or MPEG-7 descriptors, which are mainly used for image retrieval, as features of objectionable images. Such information does not properly reflect features of objectionable images, thus resulting in a low blocking rate and high mis-blocking rate. To solve this problem, in a recent scheme, a skin color is detected in pixel units, and a ratio of skin color to non-skin color in an image, etc. are used as an objectionability determination feature. However, it is also difficult for this scheme using such a feature to correctly describe and summarize the meaning of an actual objectionable image, and an objectionability classification model generated using the feature. Also, the same degree of complexity based on which an objectionable feature of an image is generated is applied to all images, and it takes much time to generate a high-level objectionable feature. Further, since images having different degrees of complexity are processed in the same way, the overall performance of an objectionable image blocking system deteriorates.

Consequently, a method of blocking an objectionable image using multi-stage objectionable image filtering in multiple scales, in which multimodal information contained in an image is used and an objectionability classification model appropriate for the degree of complexity of the image can be applied, to lower its excessive-blocking rate and mis-blocking rate and improve its processing performance and speed is needed.

### SUMMARY OF THE INVENTION

The present invention is directed to an apparatus and method analyzing and characterizing multimodal information, such as a color, texture, shape, skin color, face, edge, Motion Picture Experts Group (MPEG)-7 descriptor, object, and meaning, in multiple scales from image training data, generating objectionability classification models having multi-level complexities through machine learning using the analyzed features, and determining objectionability of a newly input image using the generated multi-level objectionability classification models to block an objectionable image.

One aspect of the present invention provides an apparatus for blocking an objectionable image on the basis of multimodal and multiscale features including: a multiscale feature analyzer for analyzing multimodal information extracted from image training data to generate multiscale objectionable and non-objectionable features; an objectionability classification model generator for compiling statistics on the generated objectionable and non-objectionable features and performing machine learning to generate multi-level objectionability classification models; an objectionability determiner for analyzing multimodal information extracted from image data input for objectionability determination to extract at least one of multiscale features of the input image, and comparing the extracted feature with at least one of the multi-level objectionability classification models to determine objectionability of the image; and an objectionable image blocker for blocking the input image when it is determined that the image is objectionable.

Another aspect of the present invention provides a method of blocking an objectionable image on the basis of multimodal and multiscale features including: analyzing multimodal information extracted from image training data to generate multiscale objectionable and non-objectionable features; compiling statistics on the generated objectionable and non-objectionable features and performing machine learning on the generated objectionable and non-objectionable features to generate multi-level objectionability classification models; analyzing multimodal information about image data input for objectionability determination to extract at least one of multiscale features of the input image; comparing the at least one multiscale feature extracted from the input image data with at least one of the multi-level objectionability classification models to determine objectionability of the input image; and blocking the input image when it is determined that the image is objectionable.

### BRIEF DESCRIPTION OF THE DRAWINGS

The above and other objects, features and advantages of the present invention will become more apparent to those of ordinary skill in the art by describing in detail exemplary embodiments thereof with reference to the attached drawings, in which:

FIG. 1 is a block diagram of an apparatus for blocking an objectionable image on the basis of multimodal and multiscale features according to an exemplary embodiment of the present invention;

FIG. 2A is a block diagram of a multiscale feature analyzer shown in FIG. 1;

FIGS. 2B to 2D are block diagrams of a coarse-grained granularity feature analyzer, a middle-grained granularity feature analyzer, and a fine-grained granularity feature analyzer of FIG. 2A, respectively;

FIG. 3 is a block diagram of an objectionability classification model generator shown in FIG. 1;

FIG. 4 is a block diagram of an objectionability determiner shown in FIG. 1; and

FIG. 5 is a flowchart illustrating a method of blocking an objectionable image on the basis of multimodal and multiscale features according to an exemplary embodiment of the present invention.

### DETAILED DESCRIPTION OF EXEMPLARY EMBODIMENTS

Hereinafter, exemplary embodiments of the present invention will be described in detail. However, the present invention is not limited to the embodiments disclosed below but can be implemented in various forms. The following embodiments are described in order to enable those of ordinary skill in the art to embody and practice the present invention. To clearly describe the present invention, parts not relating to the description are omitted from the drawings. Like numerals refer to like elements throughout the description of the drawings.

Throughout this specification, when an element is referred to as “comprises,” “includes,” or “has” a component, it does not preclude another component but may further include the other component unless the context clearly indicates otherwise. Also, as used herein, the terms “ . . . unit,” “ . . . module,” etc., denote a unit of processing at least one function or operation, and may be implemented as hardware, software, or combination of hardware and software.

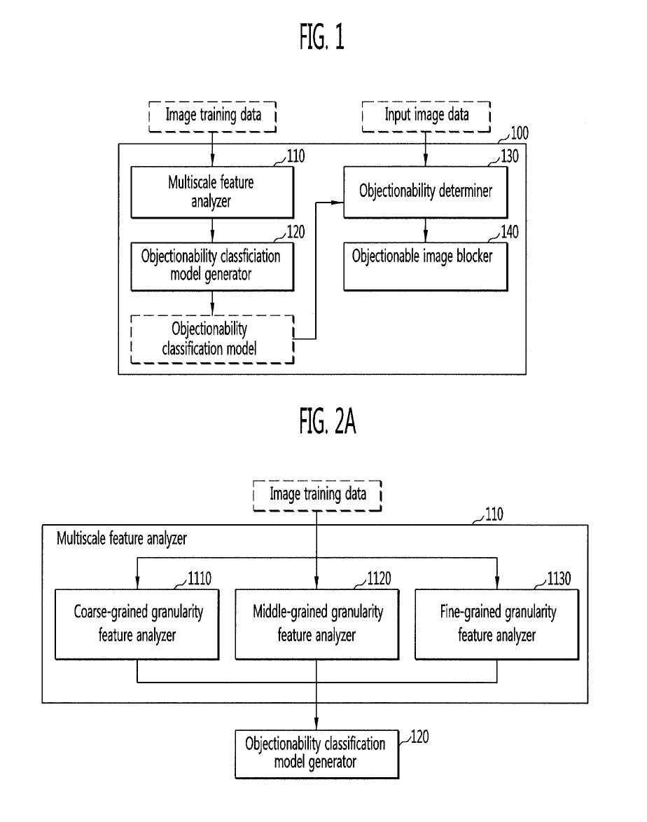

FIG. 1 is a block diagram of an apparatus for blocking an objectionable image on the basis of multimodal and multiscale features according to an exemplary embodiment of the present invention. As shown in FIG. 1, an apparatus 100 for blocking an objectionable image on the basis of multimodal and multiscale features includes a multiscale feature analyzer 110, an objectionability classification model generator 120, an objectionability determiner 130, and an objectionable image blocker 140. Image training data includes objectionable images and non-objectionable images, and is used to model objectionability of an image.

The multiscale feature analyzer 110 extracts multimodal information including a color, texture, shape, skin color, face, edge, Motion Picture Experts Group (MPEG)-7 descriptor, object, object meaning, and object relationship, and generates multiscale objectionable and non-objectionable features using the extracted multimodal information.

The objectionability classification model generator 120 compiles statistics on the objectionable and non-objectionable features generated by the multiscale feature analyzer 110, and performs machine learning, thereby generating multi-level objectionability classification models. In an exemplary embodiment, the multi-level objectionability classification models include low-level, mid-level, and high-level objectionability classification models, and are used as reference models for determining objectionability of images input thereafter.

The objectionability determiner 130 analyzes multimodal information extracted from image data input for objectionability determination to extract multiscale features, and compares the extracted features with at least one of the multi-level objectionability classification models generated by the objectionability classification model generator 120, thereby determining objectionability of the image.

The objectionable image blocker 140 blocks an input image determined to be objectionable.

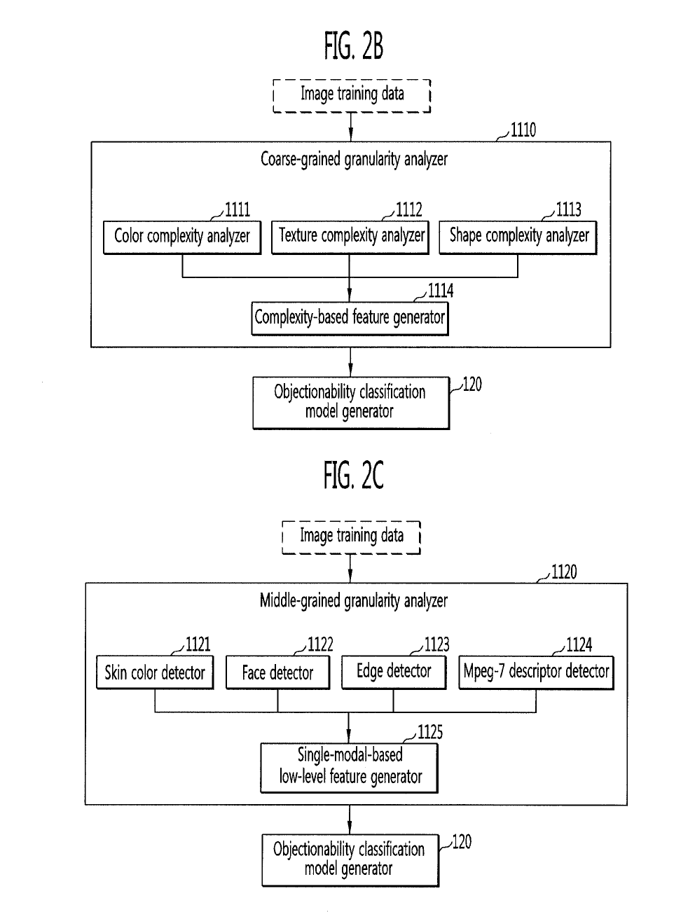

FIG. 2A is a block diagram of the multiscale feature analyzer 110 shown in FIG. 1. Referring to FIG. 2A, the multiscale feature analyzer 110 includes a coarse-grained granularity feature analyzer 1110, a middle-grained granularity feature analyzer 1120, and a fine-grained granularity feature analyzer 1130, generating objectionable and non-objectionable features in multiple scales and providing them to the objectionability classification model generator 120.

In an exemplary embodiment, the coarse-grained granularity feature analyzer 1110 analyzes the degrees of color complexity, texture complexity, and shape complexity of image training data, thereby generating a complexity-based feature.

The middle-grained granularity feature analyzer 1120 analyzes skin color, face, and edge information, and an MPEG-7 descriptor included in the image training data, thereby generating a single-modal-based low-level feature. Single-modal-based low-level features denote features generated on the basis of respective pieces of color, texture, and shape information, and are referred to as “low level” because the generated features do not include information such as meaning and correlation between pieces of information.

The fine-grained granularity feature analyzer 1130 detects objects from the image training data, and analyzes an objectionable meaning of the objects and a relationship between the objects, thereby generating a multimodal-based high-level feature.

FIGS. 2B to 2D are block diagrams of the coarse-grained granularity feature analyzer 1110, the middle-grained granularity feature analyzer 1120, and the fine-grained granularity feature analyzer 1130 of FIG. 2A, respectively.

Referring to FIG. 2B, the coarse-grained granularity feature analyzer 1110 includes a color complexity analyzer 1111 analyzing the degree of color complexity of the image training data, a texture complexity analyzer 1112 analyzing the degree of texture complexity of the image training data, a shape complexity analyzer 1113 analyzing the degree of shape complexity of the image training data, and a complexity-based feature generator 1114 generating a complexity-based feature according to the type and category of the image training data on the basis of the analyzed degrees of color, texture, and shape complexities. In an exemplary embodiment, the degrees of complexities are evaluated by analyzing the types and distributions of colors, the types and distributions of textures, the number of edges constituting a shape, the number and distributions of areas, and so on.

Referring to FIG. 2C, the middle-grained granularity feature analyzer 1120 includes a skin color detector 1121 detecting skin color information from image training data, a face detector 1122 detecting face information from the image training data, an edge detector 1123 detecting edge information from the image training data, an MPEG-7 descriptor extractor 1124 extracting an MPEG-7 descriptor from the image training data, and a single-modal-based low-level feature generator 1125 analyzing the skin color, face, and edge information and the MPEG-7 descriptor to generate a single-modal-based low-level feature according to the type and category of an image.

Referring to FIG. 2D, the fine-grained granularity analyzer 1130 includes an object detector 1131 detecting object information from image training data, an object meaning analyzer 1132 analyzing an objectionable meaning (whether or not breast exposure, genital exposure, sex, masturbation, etc. are included) of the detected objects, an object relationship analyzer 1133 analyzing a relationship between the detected objects (a part of a body, such as a face, breasts, genitals, and hips, and a whole body of a person), and a multimodal-based high-level feature generator 1134 generating a multimodal-based high-level feature according to the type and category of an image on the basis of the analyzed object meaning and object relationship. Object detection is carried out in a way that has been widely used, and object relationship analysis is carried out using information about positions, sizes, the number, etc. of the detected objects.

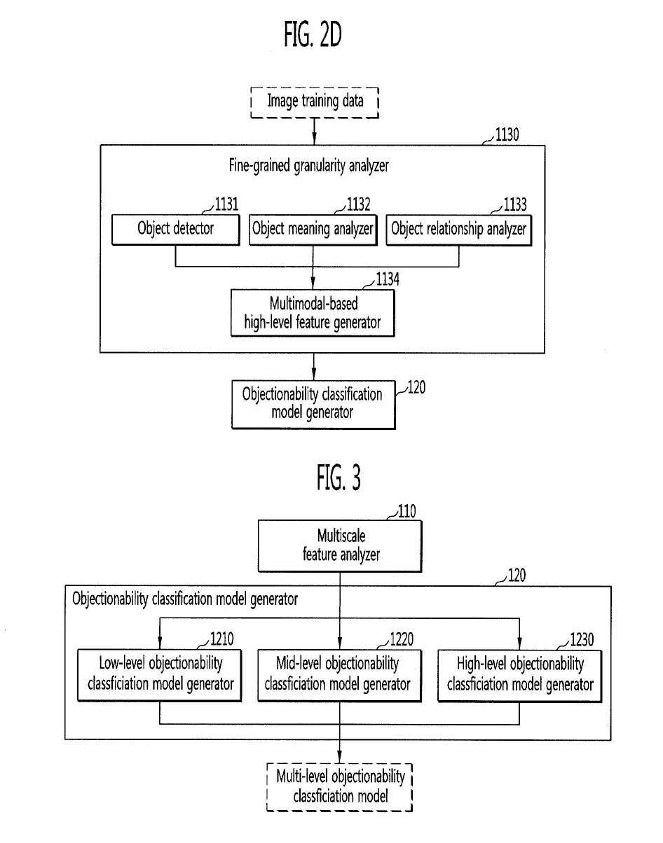

FIG. 3 is a block diagram of the objectionability classification model generator 120 shown in FIG. 1. Referring to FIG. 3, the objectionability classification model generator 120 includes a low-level objectionability classification model generator 1210 generating a low-level objectionability classification model through statistical processing and machine learning of color, texture, and shape complexity features generated by the coarse-grained granularity feature analyzer 1110 of the multiscale feature analyzer 110, a mid-level objectionability classification model generator 1220 generating a mid-level objectionability classification model through statistical processing and machine learning of features of skin color, face, and edge detection information and MPEG-7 descriptor information generated by the middle-grained granularity feature analyzer 1120 of the multiscale feature analyzer 110, and a high-level objectionability classification model generator 1230 generating a high-level objectionability classification model through statistical processing and machine learning of features of object detection information, meaning analysis information, and object relationship analysis information generated by the fine-grained granularity feature analyzer 1130 of the multiscale feature analyzer 110.

In an alternative exemplary embodiment, the objectionability classification model generator 120 may generate not only the above-mentioned low-level, mid-level, and high-level objectionability classification models but also a multi-stage objectionability classification model in which the respective level-specific objectionability classification models are combined in series or parallel.

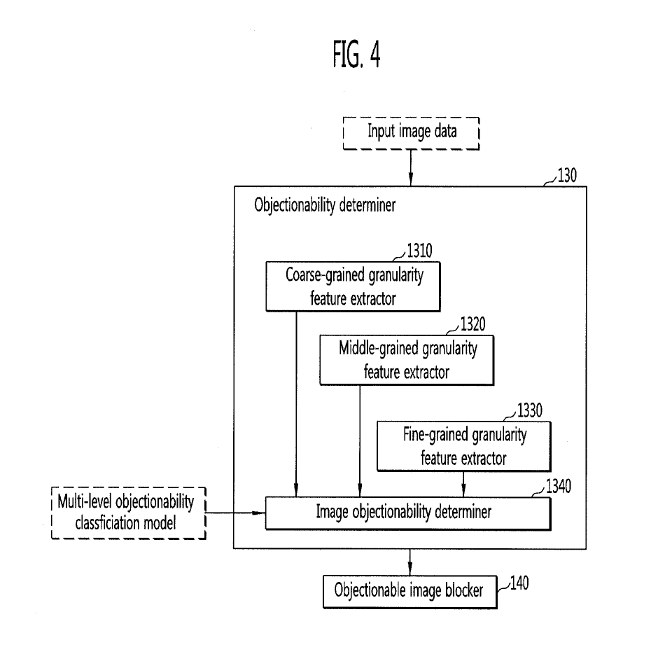

FIG. 4 is a block diagram of the objectionability determiner 130 shown in FIG. 1. Referring to FIG. 4, the objectionability determiner 130 includes a coarse-grained granularity feature extractor 1310, a middle-grained granularity feature extractor 1320, a fine-grained granularity feature extractor 1330, and an image objectionability determiner 1340. The coarse-grained granularity feature extractor 1310 analyzes color, texture, and shape complexity features of image data input as an objectionability determination target, thereby extracting a complexity-based feature of the input image data. The middle-grained granularity feature extractor 1320 analyzes at least one of pieces of skin color information, face information, and edge information, and an MPEG-7 descriptor included in the input image data, thereby extracting a single-modal-based low-level feature of the input image data. The fine-grained granularity feature extractor 1330 detects objects from the input image data and analyzes a meaning of the detected objects and a relationship between the detected objects, thereby extracting a multimodal-based high-level feature.

The coarse-grained granularity feature extractor 1310, the middle-grained granularity feature extractor 1320, and the fine-grained granularity feature extractor 1330 may operate in the same or similar way as the coarse-grained granularity feature analyzer 1110, the middle-grained granularity feature analyzer 1120, and the fine-grained granularity feature analyzer 1130 included in the multiscale feature analyzer 110 shown in FIG. 2A.

In an exemplary embodiment, a part or all of the coarse-grained granularity feature extractor 1310, the middle-grained granularity feature extractor 1320, and the fine-grained granularity feature extractor 1330 of the objectionability determiner 130 can be selected and operated according to the type and category of the input image data, and a feature of the input image generated by the selected extractor is compared with at least one of low-level, mid-level, and high-level objectionability classification models generated by the objectionability classification model generator 120 to determine objectionability of the image.

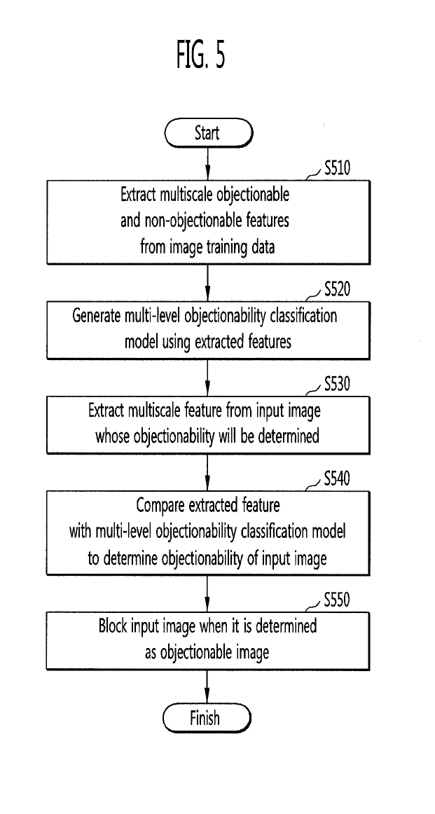

FIG. 5 is a flowchart illustrating a method of blocking an objectionable image on the basis of multimodal and multiscale features according to an exemplary embodiment of the present invention. Referring to FIG. 5, multimodal information including a color, texture, shape, skin color, face, edge, MPEG-7 descriptor, object, and object meaning extracted from image training data whose objectionability or non-objectionability has been already known is analyzed to generate multiscale objectionable and non-objectionable features using the extracted multimodal information (S510). In an exemplary embodiment, the multiscale objectionable and non-objectionable feature generation step (S510) includes a step of analyzing the degrees of color complexity, texture complexity, and shape complexity of the image training data to generate a complexity-based feature, a step of analyzing skin color, face, and edge information, and an MPEG-7 descriptor included in the image training data to generate a single-modal-based low-level feature, and a step of detecting objects from the image training data and analyzing an objectionable meaning of the objects and a relationship between the objects to generate a multimodal-based high-level feature.

Subsequently, according to the objectionable and non-objectionable features generated in step 510, multi-level objectionability classification models including low-level, mid-level, and high-level objectionability classification models are generated (S520). To be specific, the multi-level objectionability classification model generation step (S520) includes a step of generating a low-level objectionability classification model using the complexity-based feature, a step of generating a mid-level objectionability classification model using the single-modal-based low-level feature, and a step of generating a high-level objectionability classification model using the multimodal-based high-level feature. The multi-level objectionability classification models are generated as results of statistical processing and machine learning of the multiscale objectionable and non-objectionable features generated in step 510.

Subsequently, at least one multiscale feature is extracted from image data input to determine whether or not the input image data is objectionable (S530). In an example, multiscale features include a complexity-based feature, a single-modal-based low-level feature, and a multimodal-based high-level feature, and at least one of the multiscale features is extracted according to the type and category of the input image data.

Subsequently, the at least one multiscale feature extracted in step 530 is compared with at least one of multi-level objectionability classification models generated in step 520, thereby determining objectionability of the image (S540).

When the image is determined to be objectionable in step 540, the image is blocked (S550).

An exemplary embodiment of the present invention is characterized by analyzing and characterizing multimodal information, such as a color, texture, shape, skin color, face, edge, MPEG-7 descriptor, object, and meaning, in multiple scales from image training data, generating multi-level objectionability classification models through machine learning using the features, determining objectionability of a newly input image using the generated objectionability classification models, and blocking an objectionable image. By multi-stage objectionable image filtering based on multiscale features using such multimodal information, an excessive-blocking rate and mis-blocking rate of objectionable images are remarkably reduced, and processing performance and speed are improved.

As described above, an apparatus and method for blocking an objectionable image on the basis of multimodal and multiscale features according to an exemplary embodiment of the present invention can extract multiscale features and generate multi-level objectionability classification models using multimodal information contained in the image to determine objectionability of an image. As a result, multi-stage objectionability filtering appropriate for respective scales is performed according to the type and category of the image, so that an excessive-blocking rate and mis-blocking rate of objectionable images can be reduced. Also, processing performance for blocking an objectionable image can be improved to reduce required cost. Further, multi-level objectionability classification models can be applied in multiple stages, and thus it is possible to adjust the depth of image analysis and the degree of complexity of objectionable image blocking according to an application environment.

The above-described exemplary embodiments of the present invention can be implemented in various ways. For example, the exemplary embodiments may be implemented using hardware, software, or a combination thereof. The exemplary embodiments may be coded as software executable on one or more processors that employ a variety of operating systems or platforms. Additionally, such software may be written using any of a number of suitable programming languages, and also may be compiled as executable machine language code or intermediate code that is executed on a framework or virtual machine.

Also, the present invention may be embodied as a computer readable medium (e.g., a computer memory, one or more floppy discs, compact discs, optical discs, magnetic tapes, and flash memories) storing one or more programs that perform methods for implementing the various embodiments of the present invention discussed above when executed on one or more computers or other processors.

The present invention can be stored on a computer readable recording medium in the form of a computer-readable code. The computer-readable medium may be any recording device storing data that can be read by computer systems. For example, the computer-readable recording medium may be a read-only memory (ROM), a random-access memory (RAM), a compact disc (CD)-ROM, a magnetic tape, a floppy disk, and an optical data storage device. Also, the recording medium may be carrier wares (e.g., transmission over the Internet). In addition, the computer-readable recording medium may be distributed among computer systems connected via a network and stored, and executed as a code that can be read by a de-centralized method.

The apparatus and method for blocking objectionable image on the basis of multimodal and multiscale features according to an exemplary embodiment of the present invention can also be applied to portable multimedia players (MPEG layer-3 (MP3)) players, portable media players (PMPs), etc.), cellular phones, and personal digital assistants (PDAs).

While the invention has been shown and described with reference to certain exemplary embodiments thereof, it will be understood by those skilled in the art that various changes in form and details may be made therein without departing from the spirit and scope of the invention as defined by the appended claims

What is claimed is:

1. An apparatus for blocking an objectionable image on the basis of multimodal and multiscale features, comprising:
a multiscale feature analyzer for analyzing multimodal information extracted from image training data to generate multiscale objectionable and non-objectionable features;
an objectionability classification model generator for compiling statistics on the generated objectionable and non-objectionable features and performing machine learning to generate multi-level objectionability classification models;
an objectionability determiner for analyzing multimodal information extracted from image data input for objectionability determination to extract at least one of multiscale features of the input image, and comparing the extracted feature with at least one of the multi-level objectionability classification models to determine objectionability of the image; and
an objectionable image blocker for blocking the input image when it is determined that the image is objectionable.

2. The apparatus of claim 1, wherein the multiscale feature analyzer includes:
a coarse-grained granularity feature analyzer for analyzing degrees of color complexity, texture complexity, and shape complexity of the image training data to generate a complexity-based feature;
a middle-grained granularity feature analyzer for analyzing skin color, face, and edge information, and a Motion Picture Experts Group (MPEG)-7 descriptor included in the image training data to generate a single-modal-based low-level feature; and
a fine-grained granularity feature analyzer for detecting objects from the image training data and analyzing an objectionable meaning of the objects and a relationship between the objects to generate a multimodal-based high-level feature.

3. The apparatus of claim 2, wherein the coarse-grained granularity feature analyzer includes:
a color complexity analyzer for analyzing the degree of color complexity of the image training data;
a texture complexity analyzer for analyzing the degree of texture complexity of the image training data;
a shape complexity analyzer for analyzing the degree of shape complexity of the image training data; and
a complexity-based feature extractor for extracting the complexity-based feature according to a type and category of the image training data on the basis of the analyzed degrees of color, texture, and shape complexities.

4. The apparatus of claim 2, wherein the middle-grained granularity feature analyzer includes:
a skin color detector for detecting the skin color information from the image training data;
a face detector for detecting the face information from the image training data;
an edge detector for detecting the edge information from the image training data;
an MPEG-7 descriptor extractor for extracting the MPEG-7 descriptor from the image training data; and
a single-modal-based low-level feature generator for analyzing the skin color, face, and edge information and the MPEG-7 descriptor to generate the single-modal-based low-level feature according to a type and category of image training data.

5. The apparatus of claim 2, wherein the fine-grained granularity analyzer includes:
an object detector for detecting object information from the image training data;
an object meaning analyzer for analyzing the objectionable meaning of the detected objects;
an object relationship analyzer for analyzing the relationship between the detected objects; and
a multimodal-based high-level feature generator for generating the multimodal-based high-level feature according to a type and category of the image training data on the basis of the analyzed objectionable meaning and the analyzed relationship between the objects.

6. The apparatus of claim 2, wherein the objectionability classification model generator includes:
a low-level objectionability classification model generator for generating a low-level objectionability classification model using the complexity-based feature generated by the coarse-grained granularity feature analyzer;
a mid-level objectionability classification model generator for generating a mid-level objectionability classification model using the single-modal-based low-level feature generated by the middle-grained granularity feature analyzer; and
a high-level objectionability classification model generator for generating a high-level objectionability classification model using the multimodal-based high-level feature generated by the fine-grained granularity feature analyzer.

7. The apparatus of claim 1, wherein the objectionability determiner includes:
a coarse-grained granularity feature extractor for analyzing degrees of color complexity, texture complexity, and shape complexity of the input image data to extract a complexity-based feature;
a middle-grained granularity feature extractor for analyzing skin color, face, and edge information and a Motion Picture Experts Group (MPEG)-7 descriptor included in the input image data to extract a single-modal-based low-level feature;
a fine-grained granularity feature extractor for detecting objects from the input image data and analyzing an objectionable meaning of the detected objects and a relationship between the detected objects to extract a multimodal-based high-level feature; and
an image objectionability determiner for comparing at least one multiscale feature extracted by at least one of the coarse-grained granularity feature extractor, the middle-grained granularity feature extractor, and the fine-grained granularity feature extractor with at least one of the multi-level objectionability classification models to determine objectionability of the image.

8. The apparatus of claim 7, wherein a part or all of the coarse-grained granularity feature extractor, the middle-grained granularity feature extractor, and the fine-grained granularity feature extractor are selected according to a type and category of the input image data to selectively extract at least one of the multiscale features of the input image data.

9. The apparatus of claim 7, wherein the objectionability determiner selects at least one of a low-level objectionability classification model, a mid-level objectionability classification model, and a high-level objectionability classification model according to a type and category of the input image data, and compares the selected objectionability classification model with the feature of the input image data.

10. A method of blocking an objectionable image on the basis of multimodal and multiscale features, comprising:
analyzing multimodal information extracted from image training data to generate multiscale objectionable and non-objectionable features;
compiling statistics on the generated objectionable and non-objectionable features and performing machine learning on the generated objectionable and non-objectionable features to generate multi-level objectionability classification models;
analyzing multimodal information about image data input for objectionability determination to extract at least one of multiscale features of the input image;
comparing the at least one multiscale feature extracted from the input image data with at least one of the multi-level objectionability classification models to determine objectionability of the input image; and
blocking the input image when it is determined that the image is objectionable.

11. The method of claim 10, wherein generating the multiscale objectionable and non-objectionable features includes:
analyzing degrees of color complexity, texture complexity, and shape complexity of the image training data to generate a complexity-based feature;
analyzing skin color, face, and edge information, and a Motion Picture Experts Group (MPEG)-7 descriptor included in the image training data to generate a single-modal-based low-level feature; and
detecting objects from the image training data and analyzing an objectionable meaning of the objects and a relationship between the objects to generate a multimodal-based high-level feature.

12. The method of claim 11, wherein compiling the statistics on the generated objectionable and non-objectionable features and performing the machine learning on the generated objectionable and non-objectionable features to generate the multi-level objectionability classification models includes:
generating a low-level objectionability classification model using the complexity-based feature;
generating a mid-level objectionability classification model using the single-modal-based low-level feature; and
generating a high-level objectionability classification model using the multimodal-based high-level feature.

13. The method of claim 10, wherein extracting the at least one of multiscale features of the input image includes performing at least one of a step of analyzing degrees of color complexity, texture complexity, and shape complexity of the input image data and extracting a complexity-based feature on the basis of the analyzed degrees of the complexities, a step of extracting skin color, face, edge, and Motion Picture Experts Group (MPEG)-7 descriptor information from the input image data and extracting a single-modal-based low-level feature on the basis of the extracted information, and a step of analyzing object information, meaning information, and inter-object relationship information and extracting a multimodal-based high-level feature on the basis of the analysis result, to extract the at least one multiscale feature.

14. The method of claim 10, wherein extracting the at least one of multiscale features of the input image includes extracting at least one of a complexity-based feature, a single-modal-based low-level feature, and a multimodal-based high-level feature according to a type and category of the input image.
